(19) United States
(12) Patent Application Publication
(10) Pub. No.: US 2018/0214887 A1
(43) Pub. Date: Aug. 2, 2018

(54) TRIMMER DEVICE FOR PROCESSING PLANT MATERIAL

(71) Applicant: Kairos Trimmers Inc., Gold Hill, OR (US)

(72) Inventors: Matt Daniken, Gold Hill, OR (US); Dave Gran, Gold Hill, OR (US)

(21) Appl. No.: 15/881,697

(22) Filed: Jan. 26, 2018

Related U.S. Application Data
(60) Provisional application No. 62/452,928, filed on Jan. 31, 2017.

(51) Int. Cl. B02C 18/18; A01G 3/00; B02C 18/08

(52) U.S. Cl. CPC B02C 18/182; A01G 3/00; B02C 2018/164; A01G 2003/005; B02C 2018/188; B02C 18/083

(57) ABSTRACT

Embodiments are disclosed of an apparatus with a first planar cutter including a center and a plurality of through-holes and a second planar cutter positioned on the first planar cutter and including a center and a plurality of through-holes. An axle passes through the center of the first planar cutter and is coupled to the center of the second planar cutter, so that rotation of the axle produces rotation of the second planar cutter relative to the first planar cutter. At least the surface of one of the first planar cutter and the second planar cutter is made of a friction-reducing material.

### CROSS-REFERENCE TO RELATED APPLICATIONS

This application claims priority under 35 U.S.C. § 119(e) to U.S. Provisional App. No. 62/452,928, filed 31 Jan. 2017, which is hereby incorporated by reference in its entirety.

### TECHNICAL FIELD

The disclosed embodiments relate generally to trimmers and in particular, but not exclusively, to trimmers for processing plant material.

### BACKGROUND

For most agricultural plants, only a portion of the plant is usable and commercially valuable—in corn it is the ears of corn, in cannabis it is the buds, in soybeans it is the beans, etc. As a result, before the plant product is sold the commercially valuable part of the plant must be removed from the rest of the plant. And even after removal from the rest of the plant, the commercially valuable part must be further processed to remove stems or other detritus that is left after removal.

The commercially valuable parts of some plants can be rather delicate. Hand processing would be the gentlest way of processing delicate parts, but that would be very inefficient and expensive, especially for large quantities of product. There is therefore a need for plant processing machinery that can gently process the commercially valuable part of the plant in quantities large enough to be efficient.

### SUMMARY

The disclosure describes embodiments of an apparatus and system for processing plant materials.

Embodiments of the apparatus include a first planar cutter including a center and a plurality of through-holes, and a second planar cutter positioned on the first planar cutter and including a center and a plurality of through-holes. An axle passes through the center of the first planar cutter and is coupled to the center of the second planar cutter, so that rotation of the axle produces rotation of the second planar cutter relative to the first planar cutter. At least the surface of one of the first planar cutter and the second planar cutter is made of a friction-reducing material.

Embodiments of the system include a first planar cutter having a center and a plurality of through-holes and a second planar cutter positioned on the first planar cutter and including a center and a plurality of through-holes. An axle passes through the center of the first planar cutter and is coupled to the center of the second planar cutter, so that rotation of the axle produces rotation of the second planar cutter relative to the first planar cutter, and at least the surface of one of the first planar cutter and the second planar cutter is made of a friction-reducing material. A motor is coupled to the axle and a controller is communicatively coupled to the motor to control the speed of the motor, a duration of its rotation, or both.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is an exploded perspective diagram of an embodiment of a trimmer.

FIG. 2 is a flowchart of an embodiment of a process for using a trimmer such as the one shown in FIG. 1.

FIG. 3 is a pair of perspective views of an embodiment of a cutter housing, showing the housing without the cutter (top) and the housing with the cutter (bottom).

FIG. 4 is a pair of exploded perspective views of an embodiment of a pair of cutters.

FIG. 5 is a pair of perspective views of an embodiment of a cutter, showing the cutters in their operating positions (top) and an enlargement of the through-holes in a cutter (bottom).

FIGS. 6A-6B are perspective views of an embodiment of a cutter, showing support arms that can be used to support the cutter.

FIG. 7 is a side view of an embodiment of the coupling between a motor and a pair of cutters.

FIG. 8 is a plan view of an embodiment of the positioning of support arms relative to a cutter.

FIG. 9 is a perspective view of an embodiment of a cutter positioned in a drum.

FIG. 10 is a perspective view of the interior of an embodiment of the trimmer illustrating an embodiment of the positioning of a brush assembly and sweeper arms.

FIGS. 11A-11B are exploded and assembled perspective views, respectively, of an embodiment of a brush assembly.

FIG. 12 is a perspective view of an embodiment of a sweeper arm.

FIG. 13 is a block diagram of an embodiment of a system including a trimmer.

### DETAILED DESCRIPTION

Embodiments described herein variously relate to a device (referred to herein as a “trimmer device”) which is configured to trim plant material—e.g., including but not limited to hemp—using the relative motion of cutters that have variously formed therein through-holes to allow the passage of plant material.

In some embodiments, the trimmer device includes strictures to mitigate an accumulation of residue that might otherwise occur during processing to trim plant material. For example, in some embodiments, a surface portion of a cutter is formed by an ultra-high molecular weight (UHMW) polymer—e.g., including polyoxymethylene—the adhesion properties of which resist plant residue build-up. Alternatively or in addition, a cutter may be supported by an arm structure disposed at a bottom side thereof. In such an embodiment, the trimmer device is to operate while the cutter is angled relative to a horizontal plane, but where a sidewall of the arm structure is at an oblique angle to the bottom side of the cutter. Such an oblique angling, in combination with the tiling of the trimmer device, may result in the sidewall of the support arm being relatively closer to a vertical plane. Alternatively or in addition, holes formed in a cutter may be configured so that any such hole does not extend over an arm structure which extends along a bottom side of that cutter.

In embodiments, a trimmer device additionally or alternatively mitigates the possibility of mechanical damage that might otherwise result, for example, from an accumulation of plant material. For example, some embodiments provide a motor system of the trimmer device couples to one cutter, the motor system to enable relative motion of the cutter to another cutter of the trimmer device. In such an embodiment, the motor system may couple to the cutter via an axle and a clutch mechanism. The clutch mechanism may be configured to automatically disengage the motor from the axle in response to the exceeding of a threshold amount of torque.

In embodiments, a trimmer device additionally or alternatively enables improved trimming and/or improved evaluation of such trimming. For example, one or more cutters of the trimmer device may each form respective through-holes which are variously defined at least in part by beveled edge structures. Alternatively or in addition, plant material may be disposed in a drum of the trimmer device during processing thereby, wherein one or more lights disposed along sidewall structures of the drum are configured to direct light into an interior region surrounded by the drum.

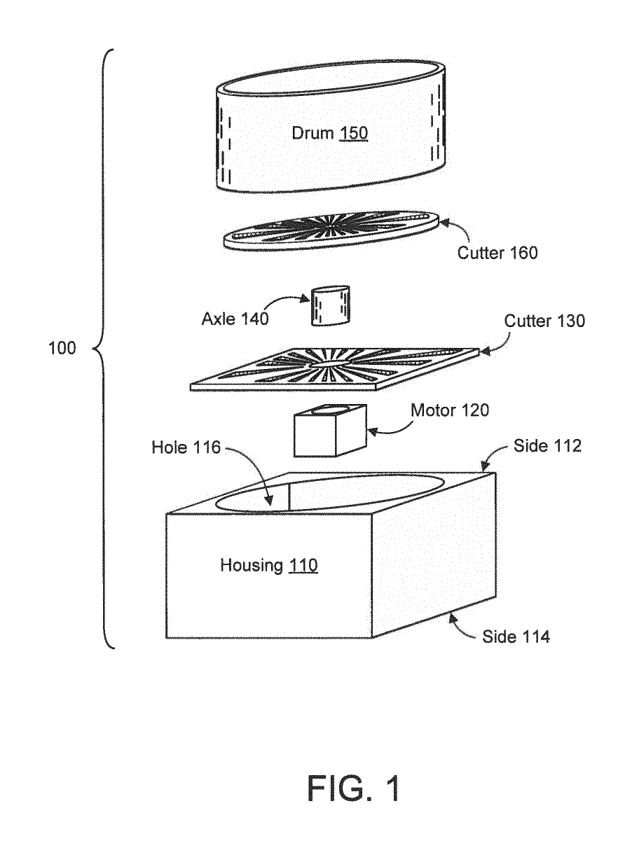

FIG. 1 shows a system 100 to process plant matter according to an embodiment. System 100 is one example of an embodiment that is configured to process plant material using the rotational motion of structures (referred to herein as “cutters”) relative to one another, the structures having variously formed therein through-holes to pass plant material which is trimmed by such rotational motion.

The system 100 may comprise a housing 110, drum 150 and one or more cutters (such as the illustrative cutters 160, 130 shown) to process plant material. Housing 100 may further include or otherwise accommodate a power delivery system (not shown) of system 100—e.g., the power delivery system configured to couple system 100 to a power supply and to variously distribute power to a control system, motor and/or other components of system 100.

Operation of system 100 may be in response to user interaction via the control system (e.g., including a user interface). While aligned with (e.g., disposed in) the drum, one or more cutters may variously spin, wherein plant material may be trimmed as a result of such spinning. Due to the trimming, some or all plant material may pass through the drum and past the one or more cutters. Trimmed plant material may be delivered to or otherwise received by a drawer of other receptacle that is included in or coupled to system 100.

As shown in the exploded view of FIG. 1, system 100 may comprise a housing 110 and components—e.g., including a motor 120, cutter 130, axle 140, drum 150 and cutter 160—which are variously disposed therein, at least in part. In an embodiment, motor 120, cutter 130, axle 140 and cutter 160 are variously aligned with drum 150—e.g., where one of cutters 130, 160 is fixedly coupled to axle 140 and motor 120 operates to turn axle 140 for rotation of the cutters 130, 160 relative to one another.

Housing 110 (comprising sheet metal, plastic and/or any of a variety of other suitable materials) may, for example, comprise a body-onframe including a body—e.g., having a uni-body construction—and a frame (or ‘chassis’) including support structures. Frame and housing portions may, for example, be integrated with one another—e.g., wherein a contiguous sheet metal (of aluminum or other such material) is stamped, pressed and/or otherwise formed into exterior shell portions and one or more structures to provide mechanical support for shell portions.

In an embodiment, housing 110 is configured to receive plant material for processing by components disposed therein. For example, a hole 116 formed in a side 112 of housing 110 may accommodate the delivery of plant material into drum 150. Side 112 may be opposite another side 114 of housing 110 which, for example, is to serve as a bottom or base of system 110. As shown in FIG. 1, sides 112, 114 may be parallel with one another. In some embodiments, housing 110 may be configured to enable an angling of drum 150 (and/or other components of system 100) relative to a horizontal plane. For example, one or more sides formed or otherwise defined by the housing may each be at a respective oblique angle to an axis of drum 150. In one such embodiment, housing 110 may be positioned at an oblique angle during operation of system 100—e.g., wherein sides 112, 114 are not parallel to one another and side 114 is to serve as a bottom (lowest) side of housing 110. Alternatively or in addition, housing 110 may include or have disposed therein an elevator motor or other such tilting mechanism of system 100 to change a variable angle of orientation of drum 150.

The power distribution system may provide power to components of system 100 such as motor 120, a control system (not shown) and/or the like. A control system of system 100 may comprise one or more mechanisms—e.g., including switches, a user interface display and/or the like—to receive input from a user and/or to provide an output (e.g., display, sound, haptic response and/or the like) indicating a state of operation of system 100. User interaction with such a control system may determine operation of (e.g., a delivery of power to) motor 120, for example.

Drum 150 may be a separate structure or, in some embodiments, may be integrated with housing 110. In an embodiment, drum 150 forms one or more sidewall structures which conform to a cylindrical shape e.g., the one or more sidewall structures extending around an interior region between opposite ends of drum 150. Some embodiments variously provide for illumination of such an interior region, where such illumination is to aid an operator in visually determining a state of plant processing performed with system 100. For example, one or more lights (not shown) may each be configured to direct light each through a respective hole formed in the sidewall structures and into an interior region surrounded by drum 150. Such one or more lights may, for example, have a Kelvin rating in a range of 3,000° to 10,000°—e.g., within a range of 4,000° to 8,000°. In an embodiment, the one or more lights include one or more light emitting diodes (LEDs)—e.g., comprising one or more organic LEDs (OLEDs). Some or all lights are each be recessed from a respective sidewall portion of drum 150, although some embodiments are not limited in this regard.

Alternatively or in addition, some embodiments variously provide structures to mitigate a build-up of residual plant matter. For example, some or all of the one or more cutters of system 100 (e.g., including cutters 130, 160) may each comprise a respective plate each having holes formed therein. For a given plate, one or more such holes formed therein may be each have a respective elongated shape—e.g., the shape extending primarily along a respective line of direction which leads generally away from a center portion of the cutter plate. As described elsewhere herein, such a cutter plate may be structurally supported at least in part by an arm structure extending along a bottom side of the plate. In such an embodiment, the cutter plate may have many holes formed therein—e.g., wherein any hole formed in the cutter plate is outside of (offset from) any location that is to be positioned above the underlying arm structure.

In various embodiments, at least one of cutters 130 and 160 can be partially or completely made of a material that is friction-reducing to reduce the friction between cutters (i.e., to increase lubricity, or make the friction between cutters less that it would be if cutters 130 and 160 were both metal) and also prevents or reduces the buildup of residual plant matter on the cutters. In embodiments that are partially made of a friction-reducing material, the friction-reducing material can be a coating deposited on the surface of the cutters.

Some embodiments variously mitigate a build-up of residual plant matter by additionally or alternatively providing an ultra-high molecular weight (UHMW) polymer throughout the cutter or at a surface of a cutter. For example, a surface of a cutter—e.g., one of cutters 130, 160—may comprise a UHMW polymer such as polyoxymethylene (or “POM”, also commonly referred to as acetal or polyacetal). As used herein, “UHMW” refers to a substance which has an average molecular weight of at least 1.0 million atomic mass units (amu)—e.g., wherein the average molecular weight is at least 3.0 million amu. In some embodiments, a cutter is made from a block (e.g., a plate) of material which includes a UHMW polymer material. Processing of the block to form holes therein may result in the UHMW material extending to a surface of the cutter which is finally formed by such processing. In other embodiments, the UHMW polymer is merely a coating material which is deposited on an underlying core material of the cutter.

Some embodiments variously mitigate a build-up of residual plant matter by additionally or alternatively providing an angling of surface structures past which plant residue may pass. For example (as described elsewhere herein), a cutter may be structurally supported at least in part by an arm structure extending along a bottom side of the plate. One or more sidewalls of such an arm structure may each extend in a respective plane which is at an oblique angle to another plane which includes the bottom side of the plate. In such an embodiment, the trimmer device may operate while in a tilted orientation—e.g., wherein the bottom side of the plate is at an angle to a horizontal plane, but wherein the angling of the one or more sidewalls of the arm structure results in the one or more sidewalls each being relatively closer to a vertical plane.

Alternatively or in addition, some embodiments variously provide for improved trimming of plant material. As detailed elsewhere herein, a cutter (e.g., one of cutters 130, 160) may have formed therein one or more holes which are variously defined at least in part by one or more beveled blade structures. Such beveled structures may be machined or otherwise formed to facilitate the trimming of plant matter. In some embodiments, the respective surfaces of some or all such beveled structures may be formed by a UHMW polymer of the cutter.

Alternatively or in addition, some embodiments variously provide mechanisms to mitigate mechanical damage that, for example, might otherwise result from a build-up of plant residue. For example, motor 120 may, in some embodiments, include or couple to a clutch protection mechanism (not shown) that is to disengage a mechanical coupling of motor 120 to axle 140. Such disengaging may, for example, be in response to detection of a threshold level of torque which is exerted on motor 120 via axle 140. In an illustrative scenario according to some embodiments, one source of such an increased torque may be an accumulation of residual plant material on and/or between moving mechanical parts that facilitate the relative motion of cutters 130, 160.

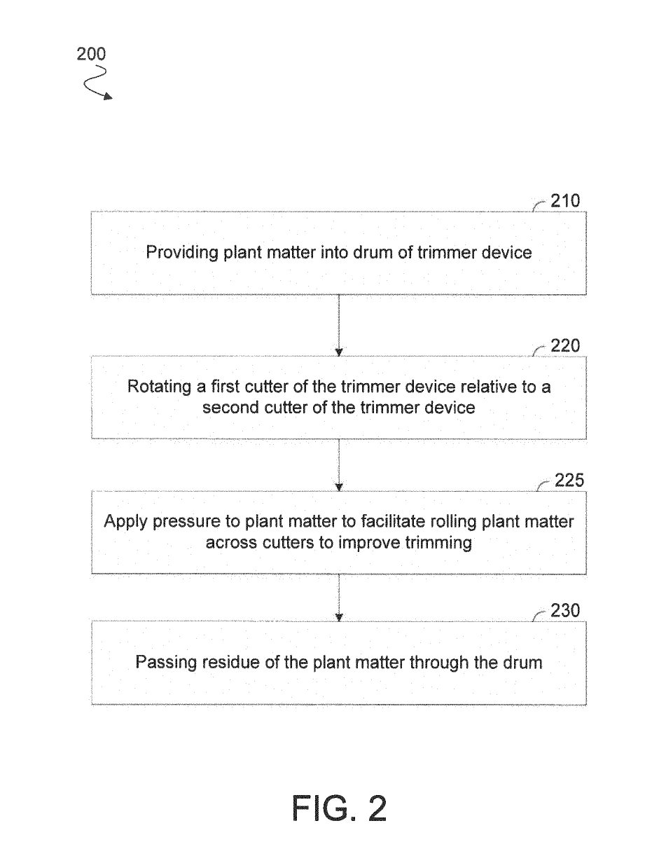

FIG. 2 shows a method 200 to operate a trimmer device according to an embodiment. Method 200 may be performed by system 100, for example. In the illustrative embodiment shown, method 200 comprises, at 210, providing plant material into a drum of a trimmer device. For example, plant material may be inserted into drum 150 via hole 116. The plant material—e.g., including hemp, hops or the like—may rest on cutter 160 during subsequent processing by method 200.

In an embodiment, method 200 further comprises, at 220, rotating a first cutter of the trimmer device relative to a second cutter of the trimmer device. In the example embodiment of system 100, motor 120 may exert torque via axle 140 to turn cutter 160 relative to cutter 130—e.g., wherein cutter 130 is fixed relative to housing 110. In some embodiments, cutter 160 is to further rotate relative to drum 150—e.g., wherein drum 150 is also fixed relative to housing 110.

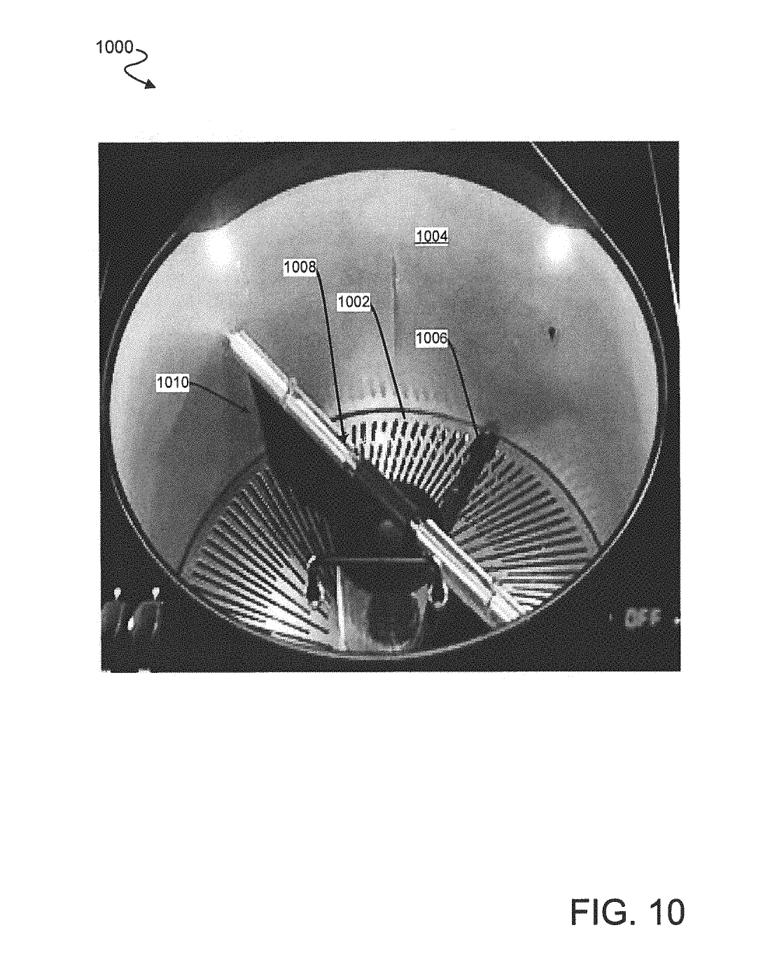

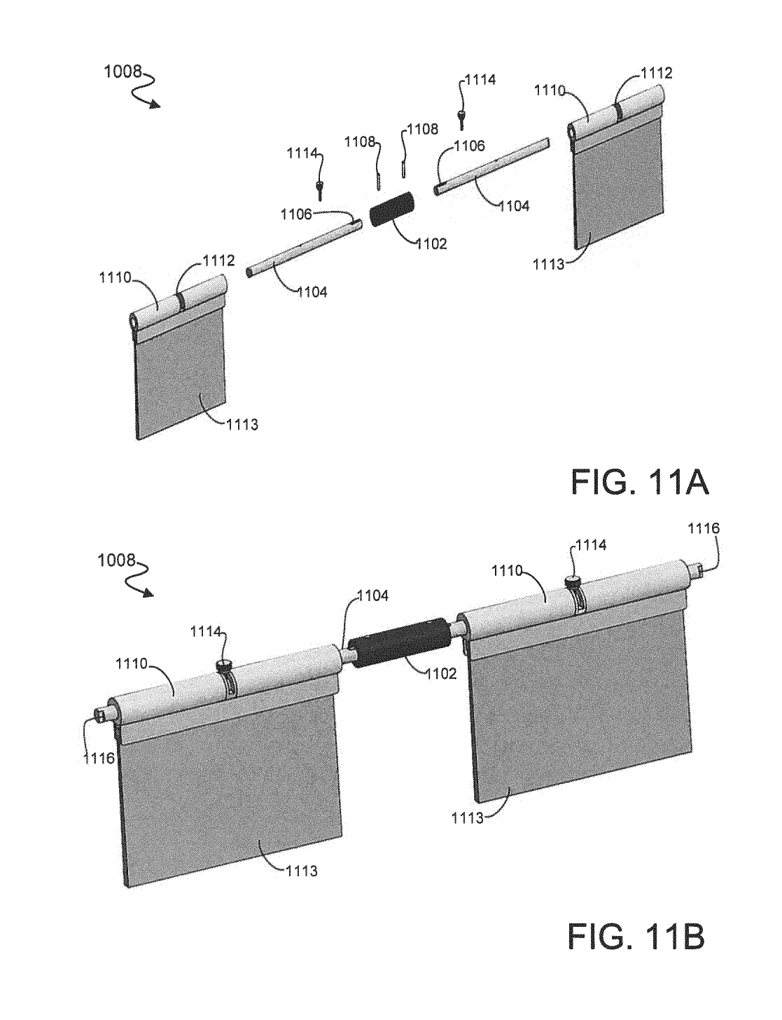

At 225, the method further comprises applying pressure on the plant matter in the trimmer to push it against the cutters and to roll the plant material across the cutters, both of which improve the trimming action of the cutters and hence the performance of the trimmers. In the embodiment of trimmer 340, the pressure is applied to the plant matter by a brush assembly positioned in the interior of drum 350, and details of an embodiment of the brush assembly are also shown in FIGS. 10 and 11A-11B.

Method 200 may further include, at 230, passing residue of the plant material through the drum. For example, portions of plant material disposed on the cutters may, due at least in part to the relative motion of such cutters at 220, be variously cut away or otherwise trimmed. Such portions may eventually be small enough to pass out of the drum—e.g., via respective holes formed in the cutters.

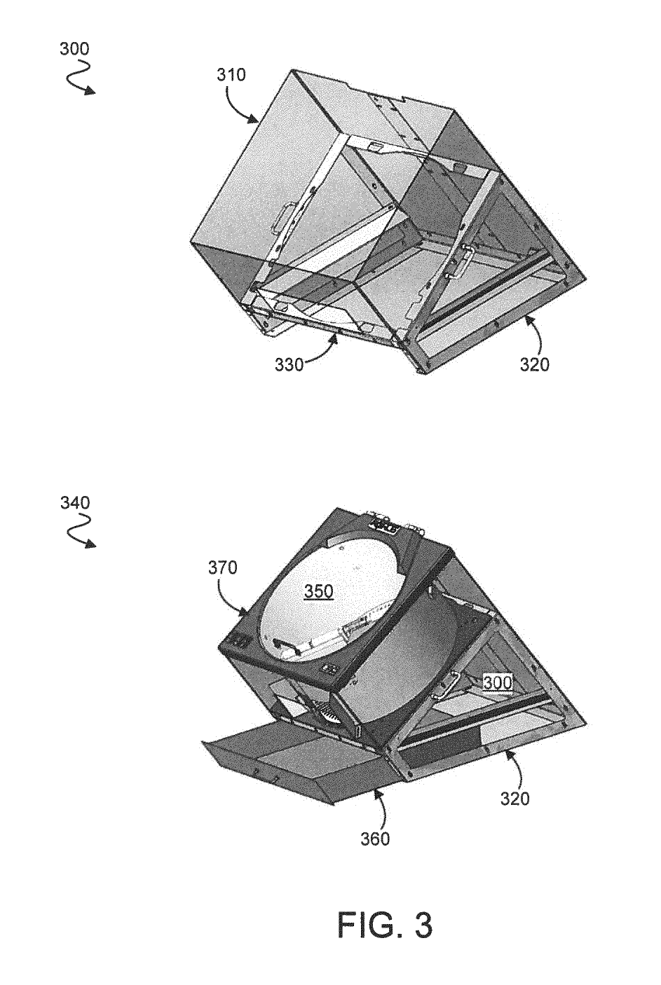

FIG. 3 shows features of a system 340 to process plant matter according to an embodiment. System 340 may include some or all of the features of system 100—e.g., wherein functionality of system 340 is to perform processes of method 200.

In an embodiment, system 340 includes a housing 300 to position a drum 350 and other components (not shown) which facilitate the relative motion of two (or more) cutters. Functionality of housing 300 and drum 350 may correspond to that of housing 110 and drum 150, respectively—e.g., wherein opposite sides 310, 320 of housing 300 correspond to sides 112, 114. Housing 300 may include a support frame 330 to facilitate mounting of other components of system 340—e.g., where such components include a cutter (such as cutter 130) a motor and/or the like.

Although some embodiments are not limited in this regard, system 340 may further comprise other components such as a drawer 360 to receive trimmed plant residue which passes out of drum 350. Such other components may additionally or alternatively include a hinged or otherwise movable lid 370 to protect an operator of system 340. In one embodiment, a portion of lid 370 is transparent (e.g., glass, plastic or the like) to allow visibility into drum 350 during trimmer processing.

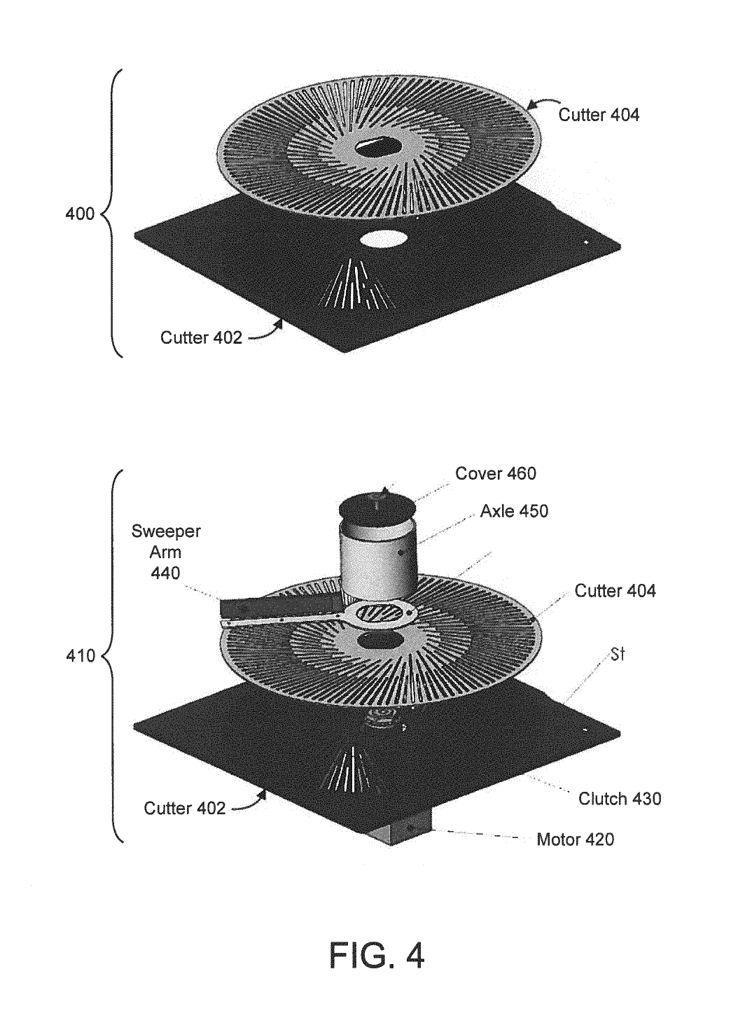

FIG. 4 shows an assembly 410 which may be used to process plant matter according to an embodiment. Assembly 410 may include features of one of systems 100, 340—e.g., wherein functionality of assembly 410 is to perform processes of method 200. A sub-assembly 400 of assembly 410 (the sub-assembly 400 including cutters 402, 404) is also shown in FIG. 4.

Assembly 410 may include cutters 402, 404, motor 420 and an axle 450 which, for example, correspond functionally to cutters 130, 160, motor 120 and axle 140, respectively. In some embodiments, at least one of cutters 402, 404 includes a UHMW polymer such as polyoxymethylene (POM). For example, an exterior surface portion of cutter 402 (and/or of cutter 404) may be formed by such a UHMW polymer. As a result, a lubricity of the surface portion may mitigate a build-up of plant residue that might otherwise result from trimming performed with a rotation of cutters 402, 404 relative to one another.

In some embodiments, a cutter may further include a Teflon (or other such polymer) coating—e.g., wherein the coating is applied thereon by anodizing, vapor coating, spray coating, powder coating or the like. The cutter may be formed from a block (e.g., a plate) of UHMW polymer material that is shaped—e.g., by waterjet cutting, milling, drilling, sawing and/or other such processing—to have formed therein through-holes that are to facilitate trimming of plant material.

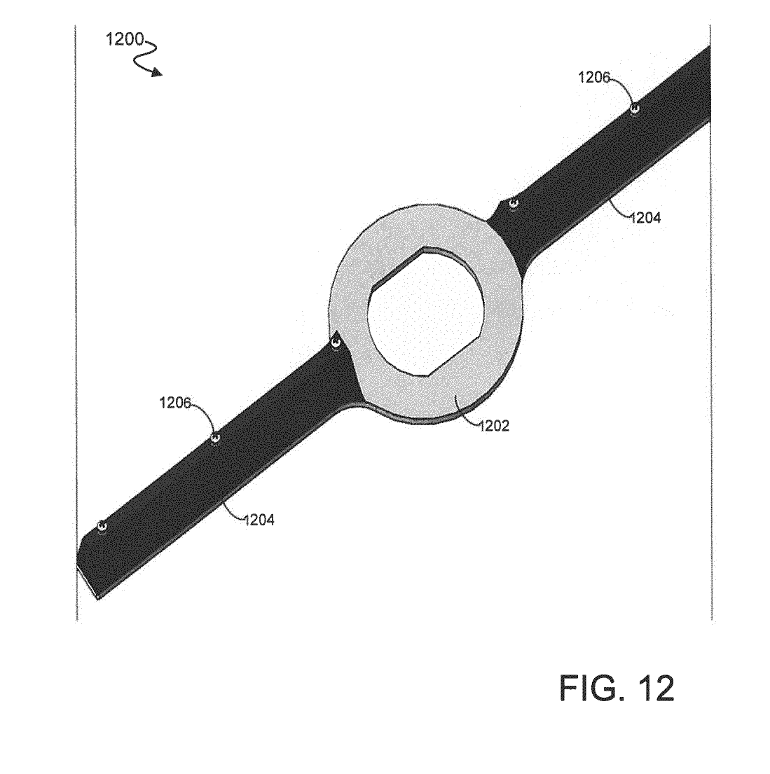

Although some embodiments are not limited in this regard, assembly 410 may alternatively or in additionally include a clutch 430 by which motor 420 is coupled to axle 450. Clutch 430 may be configured to automatically disengage cutter 404 from motor 420—e.g., in response to the exceeding of a threshold torque exerted on cutter 404 and/or on axle 450. In some embodiments, assembly 410 includes additional components, such as the illustrative removable cover 460 and sweeper arm 440. Sweeper arm 440 is attached to the surface of cutter 404 and rotates with cutter 404 to clear a surface of cutter during its rotation and to help distribute the plant matter when the trimmer is tilted so that the plant matter doesn't all bunch up in the lowest part of the trimmer. Although sweeper arms 440 and 540 are illustrated with a single segment extending radially along the cutter, in other embodiments the sweeper arms can have multiple segments (see, e.g., FIG. 12).

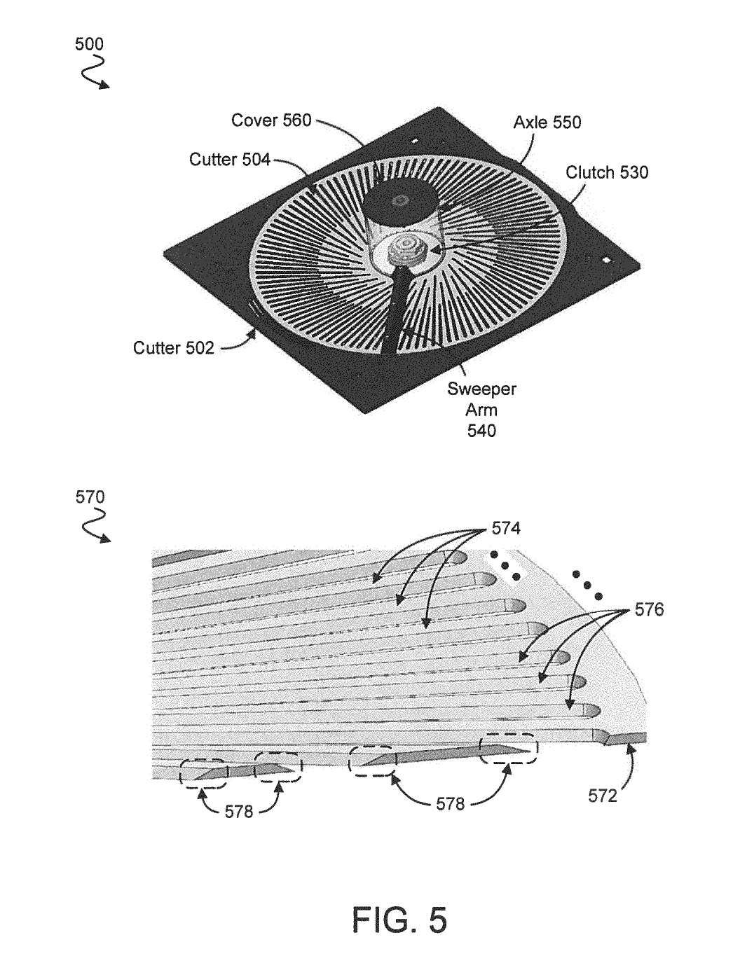

FIG. 5 shows an assembly 500 which may be used to process plant matter according to an embodiment. Assembly 500 may include features of one of systems 100, 340 and/or features of assembly 410—e.g., wherein functionality of assembly 500 is to perform processes of method 200. Assembly 500 may include cutters 502, 504, clutch 530, and an axle 550 which, for example, correspond functionally to cutters 402, 404, clutch 430, and axle 450, respectively. Although some embodiments are not limited in this regard, assembly 500 may further comprise additional components, such as the illustrative sweeper arm 540 and axle cover 560 shown. Sweeper arm 540, like sweeper arm 440, is attached to the surface of cutter 504 and rotates with cutter 504 to clear a surface of the cutter during its rotation and to help distribute the plant matter when the trimmer is tilted so that the plant matter doesn't all bunch up in the lowest part of the trimmer.

Although some embodiments are not limited in this regard, one or more cutters of assembly 500 may additionally or alternatively form through-holes, one or more of which are defined at least in part by beveled blade structures. For example, FIG. 5 also shows a cutaway view 570 of a cutter (e.g., cutter 504) comprising an outer frame portion 572 and blade structures 574 which variously extend from outer frame portion 572 toward an interior region of the cutter. Through-holes 576 which extend through the cutter may be variously formed at least in part by respective beveled sides 578 of blade structures 574. Some or all of beveled sides 578 may variously extend each in a respective plane other than any plane which is perpendicular to opposite sides of the cutter. In an illustrative embodiment, a given beveled side 578 may form an oblique angle to a top side (or bottom side) of the cutter—e.g., wherein the oblique angle is in a range of 15° to 75° (e.g., in a range of 30° to 60°).

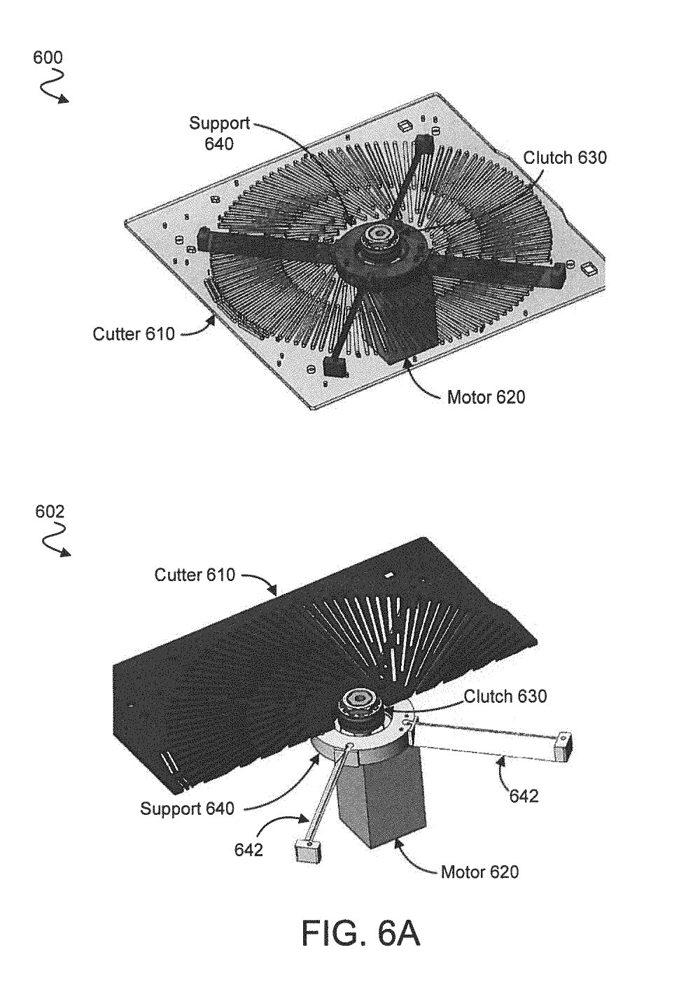

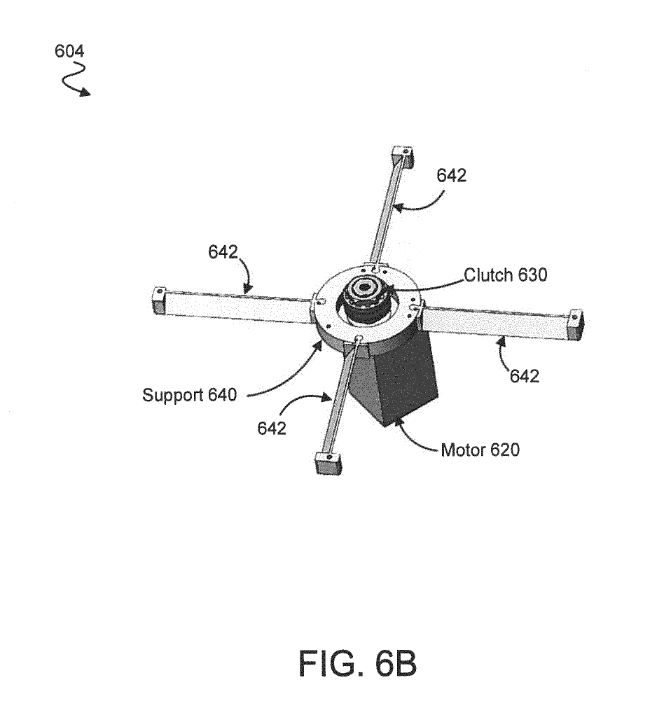

FIGS. 6A-6B show an assembly 600 which may be used to process plant matter according to an embodiment. Assembly 600 may include features of one of systems 100, 340 and/or features of one of assemblies 410, 500—e.g., wherein functionality of assembly 600 is to perform processes of method 200. In the illustrative embodiment shown, assembly 600 includes a motor 620, cutter 610 and clutch 630 which, for example, correspond functionally to motor 420, cutter 402 and clutch 430, respectively.

As shown in cutaway view 602 of assembly 600, some embodiments may provide a structure (such as the illustrative support 640 shown) to structurally reinforce cutter 610. Support 640 is merely one example of any of a variety of structures which include one or more arm portions (e.g., including the illustrative arms 642 shown) which extend along an underside of a cutter such as cutter 610. By way of illustration and not limitation, support 640 may include a collar portion which is to extend around an axis of motor 620 and/or clutch 630, wherein arms 642 of support 640 variously extend from the collar portion. In some embodiments, a bottom side of cutter 610 and a respective sidewall of one of arms 642 are in a first plane and a second plane, respectively. In such an embodiment, the first plane and the second plane may be at an oblique angle to one another—e.g., wherein the angle is in a range of 15° to 75° (e.g., in a range of 25° to 65°). In such an embodiment, a trimming device including assembly 600 may operate while cutter 610 is at an angle to a horizontal plane, wherein the oblique angling of respective sidewalls of arms 642 results in such sidewalls being relatively more aligned along a vertical plane. In one embodiment, multiple ones of arms 642 each include a respective sidewall which is parallel to a first plane that, in turn, is at an oblique angle to a side (e.g., one of a top side and a bottom side) of cutter 610. Another view 604 in FIG. 6B shows details of such angled components in assembly 600.

Although some embodiments are not limited in this regard, a trimming device may additionally or alternatively include a clutch mechanism such as the illustrative clutch 630 shown. The clutch may provide direct or indirect connection between motor 620 and a cutter (e.g., 504) which, for example, is to rotate relative to cutter 610. Clutch 630 may include replaceable clutch discs and/or may be adjustable to provide any of a variety of torque setting. Clutch 630 may mitigate jamming, failure and/or damage to motor 620 that, for example, might otherwise occur due to a build-up of plant residue (e.g., on the cutters and/or between moving components such as a motor, axle, etc.). In an illustrative scenario according to one embodiment, clutch 630 may be adjustably set to disengage motor 620 from a cutter in response to a threshold torque that, for example, is in a range of 65 inch-pounds (in-lbs) to 125 in-lbs. However, such a threshold torque level may vary in different embodiments, according to implementation-specific details. Setting of a threshold torque level for clutch 630 may be performed with torque wrench, load cell, spring tension or other such mechanism—e.g., where access to clutch 630 is via removable cover 560 or other such mechanism. In some embodiments, clutch 630 may be reset automatically after clearing of a jam at the trimmer device results in a reduction of torque exerted at the axle.

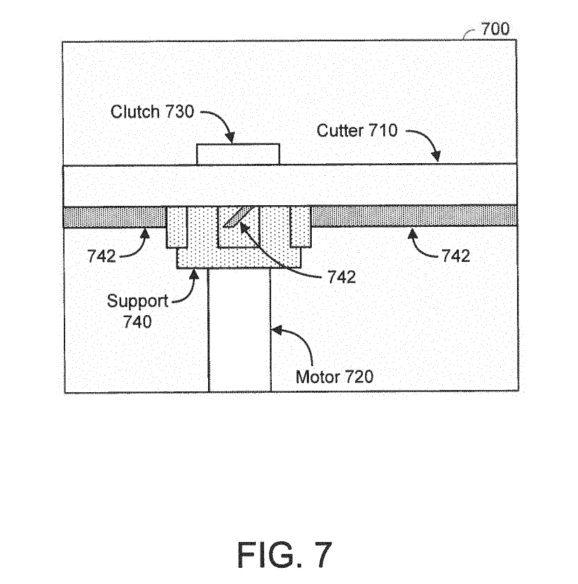

FIG. 7 shows an assembly 700 which may be used to process plant matter according to an embodiment. Assembly 700 may include features of one of systems 100, 340 and/or features of one of assemblies 410, 500 and 600—e.g., wherein functionality of assembly 700 is to perform processes of method 200. In the illustrative embodiment shown, assembly 700 includes a motor 720 a cutter 710, clutch 730 and a support 740 which, for example, may correspond functionally to motor 620 a cutter 610, clutch 630 and a support 640. Another cutter (not shown) may be disposed on cutter 710, where clutch 730 is to provide for engagement—through a hole extending through cutter 710—between motor 720 and the other cutter.

In order to provide structural support for cutter 710 during operation of assembly 700, support 740 may include or couple to arm portions 742 which variously extend along the bottom side of cutter 710 away from an axis of motor 720 toward a peripheral edge (not shown) of cutter 710. For some or all of arm portions 742, one or more respective sidewalls of the arm portion may extend in a direction that is at an oblique angle to a side (e.g., a top side or a bottom side) of cutter 710. Alternatively or in addition, such one or more respective sidewalls may each be at a respective oblique angle to the axis of motor 720. Such angling may mitigate an accumulation of plant matter during operation of assembly 700—e.g., where such operation takes place while the axis of motor 720 is angled relative to a vertical axis. The angling of arm portions 742, in combination with a tilting of assembly 700 from a directly vertical orientation, may mitigate an accumulation of plant residue on art portions 742 and/or on portions of cutter 710 which are positioned vertically over arm portions 742.

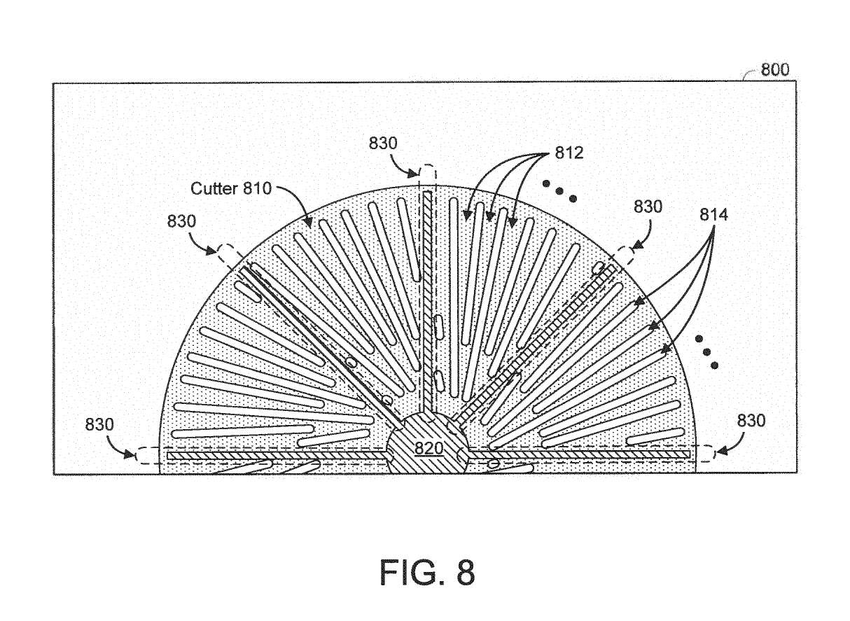

FIG. 8 shows an assembly 800 which may be used to process plant matter according to an embodiment. Assembly 800 may include features of one of systems 100, 340 and/or features of one of assemblies 410, 500, 600 and 700—e.g., wherein functionality of assembly 800 is to perform processes of method 200.

Assembly 800 is one example of an embodiment wherein a trimmer device includes a cutter and a support structure extending along a bottom side of the cutter, wherein any holes which extend through the cutter are each positioned at a respective location other than any which is directly over the through support structure. In the illustrative embodiment shown, assembly 800 includes a cutter 810 and a support 820 which, for example, may correspond functionally to cutter 610 and support 640. Support 820 may include one or more arm structures which extend each under a respective region 830 of a bottom surface of cutter 810. Cutter 810 may include blade structures 812, the respective sides of which variously define at least in part through-holes 814 extending through cutter 810. In such an embodiment, through-holes 814 are each located outside of any of the regions 830 under which the arm portions of support structure 820 extend. Such positioning of through-holes 814 outside of regions 830 may mitigate an accumulation of plant residue on top of such arm portions.

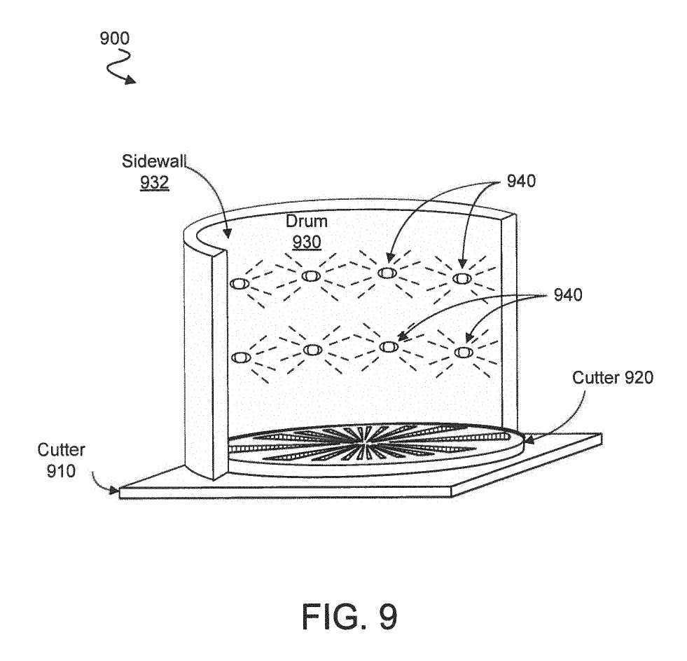

FIG. 9 shows a system 900 which may be used to process plant matter according to an embodiment. System 900 may include features of one of systems 100, 340 and/or features of one of assemblies 410, 500, 600, 700 and 800—e.g., wherein functionality of system 900 is to perform processes of method 200. System 900 is one example of an embodiment wherein lights are positioned to direct light into an interior region of a trimmer device—e.g., where such illumination is to aid an operator in visually determining a state of processing to trim plant material.

In the illustrative embodiment shown, system 900 includes cutters 910, 920 and a drum 930 that, for example, correspond functionally to cutters 130, 160 and drum 150, respectively. One or more lights (such as the illustrative lights 940 shown) may be variously configured to direct light each through a respective hole formed in a sidewall 932 and into an interior region surrounded by drum 930. Some or all of lights 940 may, for example, have a Kelvin rating in a range of 3,000-10,000—e.g., within a range of 4,000 to 8,000. In an embodiment, the one or more lights 940 include one or more light emitting diodes (LEDs)—e.g., comprising one or more organic LEDs (OLEDs). Some or all lights 940 may each be recessed from a respective portion of sidewall 932, although some embodiments are not limited in this regard. Lights 940 may be evenly spaced, radially and/or vertically, around sidewall 932. However, some embodiments are not limited in this regard, and the particular number and configuration of lights 940 may vary in different embodiments according to implementation-specific details.

FIG. 10 illustrates an embodiment of trimmer 1000 including an embodiment of a brush assembly. Cutter 1002 is positioned in the interior of drum 1004. Brush assembly 1008 is positioned on the central hub of cutter 1002 and its ends are engaged in D-shaped slots in the interior wall of drum 1004, so that brush assembly 1008 is fixed relative to the drum. In other embodiments, brush assembly 1008 can be coupled to trimmer 1000 differently than shown. Brush assembly 1008 includes a pair of brushes 1010 (only one is clearly visible in the figure) that extend from the brush assembly toward cutter 1002, such that the ends of its bristles are in contact with, or within a certain distance of, the surface of cutter 1002. Because brush assembly 1008 is fixed relative to drum 1004 but cutter 1002 rotates relative to drum 1104, the surface of cutter 1002 moves relative to the bristles of brushes 1010. Brushes 1010 apply pressure on plant matter put in the trimmer to push it against cutter 1002 and to roll the plant material across the cutter, both of which improve the trimming action of the cutter and hence the performance of the trimmer. Details of brush assembly 1008 are described below in connection with FIGS. 11A-11B.

FIGS. 11A-11B together illustrate an embodiment of a brush assembly 1008; FIG. 11A is an exploded view, FIG. 11B an assembled view. Brush assembly 1008 includes a central portion 1102 which rests on or in the trimer hub (see FIG. 10). A pair of arms 1104 each has one end with a slot 1106 and another end with a D-shaped protrusion 1116 to engage a corresponding D-shaped hole in the drum wall, but in other embodiments brush assembly 1008 can be coupled to the drum wall differently than shown. The slotted end of each arm 1104 is inserted into central portion 1102, and pins 1108 are inserted through central portion 1102 and into slots 1106 to retain arms 1104 within central portion 1102. Slots 1106 allow arms 1104 to translate radially (i.e., along their own longitudinal axes) to engage the drum walls. A spring (not shown) positioned within central portion 1102 can provide an outward radial force that pushes arms 1104 radially outward so that they remain engaged with the drum walls.

A pair of sleeves 1110 each has a slot 1112 and an attached brush 1113. Each arm 1104 is inserted into a corresponding sleeve 1110, and sleeves 1110 are held in place by set screws 1114 that are inserted into slots 1112. Slots 1112, in addition to being used to retain sleeves 1110 on arms 1104, allow sleeves 1110 to rotate around the axes of arms 1104. As a result, sleeves 1110 can be adjusted to any angle relative to the axis of arms 1104 and fixed in position at that angle using set screws 1104. By adjusting the angle of sleeves 1110 relative to arms 1104, the angles of brushes 1113 relative to the cutter—and hence the downward pressure and rolling action created by the brushes—can also be adjusted.

FIG. 12 illustrates an embodiment of a sweeper arm 1200.

Sweeper arm 1200 is similar in most respects to sweeper arms 440 (FIG. 4) and 540 (FIG. 5). It is coupled to the trimmer hub using central portion 1202 and its arms 1204 are coupled to the cutter itself using screws 1206, such that sweeper arm 1200 rotates together with the cutter to clear a surface of the cutter during its rotation and to help distribute the plant matter when the trimmer is tilted so that the plant matter doesn't all bunch up in the lowest part of the trimmer. The primary difference between cutter 1200 and cutters 440 and 540 is that sweeper arm 1200 includes multiple radially-extending segments 1204 instead of just one. In the illustrated embodiment sweeper arm 1200 includes two segments 1204, but other embodiments can include an number more than two segments. And although in the illustrated embodiment the angular distribution of segments is regular (i.e., segments are 180 degrees apart in a twosegment embodiment, 120 degrees apart in a three-segment embodiment, etc.), in other embodiments the angular distribution of segments need not be regular (i.e., the angles between segments need not be equal).

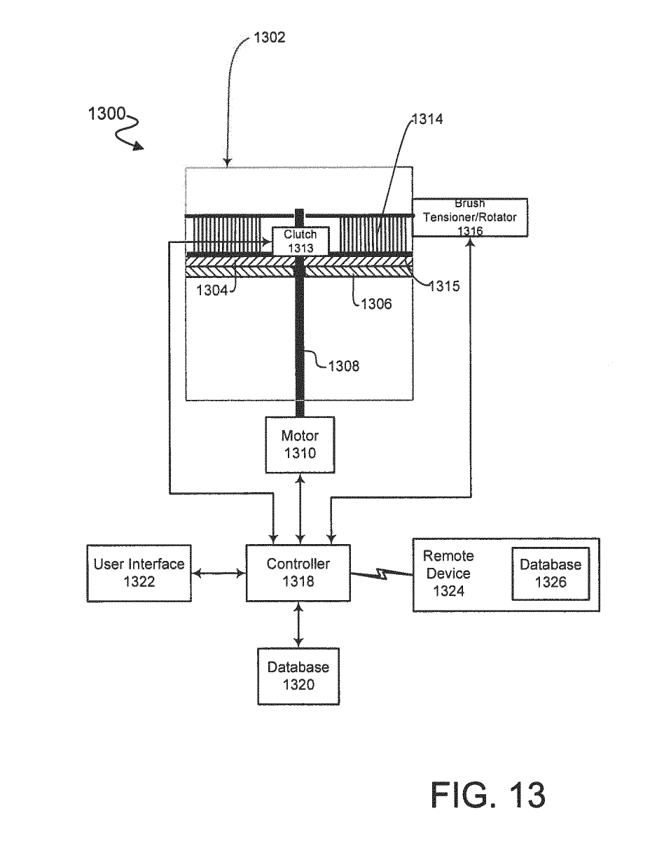

FIG. 13 illustrates an embodiment of a system 1300 for trimming plant material. System 1300 includes a trimmer 1302 that can be any of the trimmer embodiments discussed in this application; trimmer 1302 includes a second cutter 1304 and a first cutter 1306. Cutter 1304 includes sweeper arm 1315 and is coupled via clutch 1312 to axle or shaft 1308, and axle 1308 is in turn coupled to motor 1310. A brush assembly 1314 is positioned to brush the top surface of cutter 1304 when cutter 1304 is rotated by axle 1308 and clutch 1312.

A controller 1318 is communicatively coupled to motor 1310, clutch 1312, and brush tensioner/rotator 1316, meaning that controller 1318 is coupled to the other components in such a way that they can exchange data, commands, or both. Controller 1318 is also coupled to one or more databases 1320 and a user interface 1322. Controller 1318 can also be coupled, for instance through a wireless protocol like Bluetooth or Wi-Fi, to a remote device 1324 that can include its own database 1326.

In one embodiment, controller 1318 is a computer including at least a microprocessor, memory, and storage. Controller 1318 also includes instructions stored thereon to control trimmer 1302. Database 1320 can be stored in controller 1318 or in a device external to the controller. User interface 1322 can be any device through which a user can input commands and data for controller 1318; examples include a keyboard/screen combination, a touch screen, a switch panel with a series of controls and/or displays, etc. User interface 1322 can also provide feedback to the user in the form of text, graphics, sound, or haptic feedback. In embodiments that can use remote device 1324 to communicate with controller, remote device 1324 can be a mobile phone or other type of wireless devices such as a desktop computer with wireless capability, a tablet, a purpose-built remote control, etc. Remote device 1324 can include its own database 1326 which can either replace or supplement database 1320.

In operation of system 1300, controller 1318 can be used to control motor 1310, clutch 1312, and brush tensioner/rotator 1316. For instance, it can control the speed (i.e., angular velocity) and direction (forward or backward) of motor 1310; it can control the torque at which clutch 1312 disengages axle 1308 from cutter 1304; and it can control the settings of brush tensioner/rotator 1314 to adjust the angle and resistance presented by brush assembly 1314 as it brushes the surface of the cutter.

In one embodiment controller 1318 can control the operation of these elements—motor 1310, clutch 1312, and brush tensioner/rotator 1316—based on input by user through user interface 1322. But in other embodiments controller 1318 can control these elements based on information stored in one or both of databases 1320 and 1326. For instance, databases 1320 and 1326 can include information on different plants or plant strains and the operational variables that should be used to process that particular plant or plant strain in the trimmer. For instance, operational variables that can be different for different plants or plant strains include motor speed, cycle duration (i.e., how long the plant or plant strain must be processed in the trimmer), torque at which clutch 1312 should release cutter 1304 from axle 1308 (e.g., in case the machine jams), and brush tension and angle settings for brush tensioner/rotator 1316.

Techniques and architectures for processing plant material are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense.

What is claimed is:

1. An apparatus comprising:
a first planar cutter including a center and a plurality of through-holes;
a second planar cutter positioned on the first planar cutter and including a center and a plurality of through-holes; and
an axle passing through the center of the first planar cutter and coupled to the center of the second planar cutter, so that rotation of the axle produces rotation of the second planar cutter relative to the first planar cutter;
wherein at least the surface of one of the first planar cutter and the second planar cutter is made of a friction-reducing material.

2. The apparatus of claim 1 wherein at least one of the first and second planar cutters is made entirely of the friction-reducing material.

3. The apparatus of claim 2 wherein the friction-reducing material is an ultra high molecular weight (UHMW) polymer.

4. The apparatus of claim 1, further comprising a clutch coupled between the axle and the second planar cutter wherein the clutch allows the second planar cutter to be disengaged from the axle.

5. The apparatus of claim 4 wherein the clutch can be adjusted to disengage the second planar cutter from the axle when the torque applied by the axle exceeds a certain value.

6. The apparatus of claim 1 wherein at least part of an edge of at least one through-hole in one of the first and second planar cutters is beveled to produce a sharp edge.

7. The apparatus of claim 1 wherein the through-holes in the first planar cutter and the through-holes in the second planar cutter are elongated holes that extend from a circle surrounding the center to a position near the perimeter of the cutter.

8. The apparatus of claim 1, further comprising a motor coupled to the axle.

9. The apparatus of claim 1, further comprising a plurality of support arms coupled to a side of the first planar cutter opposite the side where the second planar cutter is positioned, the plurality of support arms extending radially from a position at or near the center of the first planar cutter to a position at or near the perimeter of the first planar cutter.

10. The apparatus of claim 9 wherein each of the plurality of support arms include a planar portion and wherein the planar portion is oriented at an angle relative to a plane of the first planar cutter.

11. The apparatus of claim 9 wherein the plurality of support arms are positioned relative to the first planar cutter so that they do not coincide with any through-holes in the first planar cutter.

12. The apparatus of claim 1 wherein at least two of the plurality of through-holes in the first planar cutter have different dimensions and wherein at least two of the plurality of through-holes in the second planar cutter have different dimensions.

13. The apparatus of claim 1, further comprising a brush assembly positioned to brush a surface of the second planar cutter as it rotates.

14. The apparatus of claim 1, further comprising a cylindrical drum surrounding the first planar cutter and the second planar cutter, wherein an axis of the cylindrical drum coincides with an axis of the axle and wherein the sidewall of the cylindrical drum coincides with the perimeters of the first and second planar cutters.

15. The apparatus of claim 14, further comprising one or more lights positioned in the sidewall of the cylindrical drum to shine light into the interior of the cylindrical drum.

16. The apparatus of claim 14, further comprising a housing to contain at least the drum and the first and second planar cutters.

17. The apparatus of claim 16 wherein the drum and the first and second planar cutters are positioned so that an axis of the drum and the planes defined by the first and second planar cutters are positioned at an angle relative to a horizontal plane.

18. A system comprising:
a trimmer comprising:
a first planar cutter including a center and a plurality of through-holes,
a second planar cutter positioned on the first planar cutter and including a center and a plurality of through-holes, and
an axle passing through the center of the first planar cutter and coupled to the center of the second planar cutter, so that rotation of the axle produces rotation of the second planar cutter relative to the first planar cutter, wherein at least the surface of one of the first planar cutter and the second planar cutter is made of a friction-reducing material, and
a motor coupled to the axle; and
a controller communicatively coupled to the motor to control the speed of the motor, a duration of its rotation, or both.

19. The system of claim 18, further comprising a user interface coupled to the controller.

20. The system of claim 18, further comprising a remote device communicatively coupled to the controller.

21. The system of claim 20 wherein the remote device is a mobile phone.

22. The system of claim 20 wherein the remote device includes a database with information on plants or strains of plants and the operational variables needed for processing a particular plant or strain of plant.

23. The system of claim 18, further comprising a database coupled to the controller, wherein the database includes information on plants or strains of plants and the operational variables needed for processing a particular plant or strain of plant.

24. The system of claim 18, further comprising a clutch coupled between the axle and the second planar cutter, wherein the clutch allows the second planar cutter to be disengaged from the axle and wherein the clutch is communicatively coupled to the controller.

25. The system of claim 24 wherein the clutch can be commanded by the controller to disengage the second planar cutter from the axle when the torque applied by the axle exceeds a certain value.

26. The system of claim 1, further comprising:
a brush assembly positioned to brush a surface of the second planar cutter as it rotates; and
a brush tensioner/rotator coupled to the sweeper arm to adjust the brushing resistance of the brush assembly, the brush tensioner/rotator being communicatively coupled to the controller.

27. The system of claim 19, further comprising a cylindrical drum surrounding the first planar cutter and the second planar cutter, wherein an axis of the cylindrical drum coincides with an axis of the axle and wherein the sidewall of the cylindrical drum coincides with the perimeters of the first and second planar cutters.

28. The system of claim 18, further comprising a housing to contain at least the cylindrical drum and the first and second planar cutters.

29. The system of claim 28 wherein the drum and the first and second planar cutters are positioned so that an axis of the drum and the planes defined by the first and second planar cutters are positioned at an angle relative to a horizontal plane.

30. The system of claim 18 wherein at least one of the first and second planar cutters is made entirely of the friction-reducing material.

31. The system of claim 30 wherein the friction-reducing material is an ultra high molecular weight (UHMW) polymer.

32. The system of claim 18 wherein at least part of an edge of at least one through-hole in one of the first and second planar cutters is beveled to produce a sharp edge.

33. The system of claim 18 wherein the through-holes in the first planar cutter and the through-holes in the second planar cutter are elongated holes that extend from a circle surrounding the center to a position near the perimeter of the cutter.
